(19) United States
(12) Patent Application Publication
(10) Pub. No.: US 2025/0304474 A1
(43) Pub. Date: Oct. 2, 2025

(54) METHODS FOR FILTRATION OF SALT WATER OR CONTAMINATED LIQUIDS USING NANO-STRUCTURES AND MAGNETIC FILTERS

(71) Applicant: Malek Shayan, Reno, NV (US)

(72) Inventor: Malek Shayan, Reno, NV (US)

(21) Appl. No.: 19/096,335

(22) Filed: Mar. 31, 2025

Related U.S. Application Data
(60) Provisional application No. 63/573,064, filed on Apr. 2, 2024.

(51) Int. Cl. C02F 1/48; C02F 1/00; C02F 101/20; C02F 103/08

(52) U.S. Cl. CPC C02F 1/488; C02F 1/001; C02F 2101/20; C02F 2103/08; C02F 2201/001; C02F 2201/007

(57) ABSTRACT

A system may include a fluid containing impurities. A system may include at least one particle disposed with the fluid, the at least one particle exhibiting magnetic behavior and configured to capture the impurities. A system may include at least one magnetic filter configured to attract at least one particle with the fluid.

### PRIORITY, CROSS-REFERENCE, AND INCORPORATION

This application claims priority to U.S. Provisional Patent Application No. 63/573,064 filed Apr. 2, 2024. The entire contents of the above are hereby incorporated into this document by reference and made a part of this specification for all purposes, for all that it contains. Moreover, any and all applications for which a foreign or domestic priority claim is identified in the Application Data Sheet of the present application are hereby incorporated by reference under 37 C.F.R. § 1.57.

### FIELD OF THE INVENTION

This is application is generally directed to water filtration systems.

### SUMMARY OF THE INVENTION

In some aspects, the techniques described herein relate to a magnetic filtration system including: a fluid containing impurities; at least one particle disposed with the fluid, the at least one particle exhibiting magnetic behavior and configured to capture the impurities; and at least one magnetic filter configured to attract at least one particle with the fluid.

In some aspects, the techniques described herein relate to a magnetic filtration system, wherein the fluid is dirty water.

In some aspects, the techniques described herein relate to a magnetic filtration system, wherein the dirty water is salt water.

In some aspects, the techniques described herein relate to a magnetic filtration system, wherein the at least one particle includes a metal-organic framework (MOF).

In some aspects, the techniques described herein relate to a magnetic filtration system, wherein the MOF includes at least one of the following: a ZIF-88 membrane, a UiO-66 membrane or PSP-MIL-53.

In some aspects, the techniques described herein relate to a magnetic filtration system, wherein the MOF exhibits ion selectivity, such that a targeted ion can be captured within a structure of MOF.

In some aspects, the techniques described herein relate to a magnetic filtration system, wherein the MOF exhibits alkali metal ion selectivity.

In some aspects, the techniques described herein relate to a magnetic filtration system, wherein the MOF exhibits sodium ion selectivity.

In some aspects, the techniques described herein relate to a magnetic filtration system, wherein the at least one particle exhibits at least one of the following magnetic behaviors: ferromagnetism, ferrimagnetism, or paramagnetism.

In some aspects, the techniques described herein relate to a magnetic filtration system, wherein the at least one particle is ferroelectric.

In some aspects, the techniques described herein relate to a magnetic filtration system, wherein the at least one magnetic filter includes a plurality of magnetic filters.

In some aspects, the techniques described herein relate to a magnetic filtration system, wherein the at least one magnetic filter is disposed on a fluid line configured to transport the fluid.

In some aspects, the techniques described herein relate to a magnetic filtration system, wherein the at least one magnetic filter is removably attached to the fluid line.

In some aspects, the techniques described herein relate to a magnetic filtration system, wherein the at least one magnetic filter is attached to the fluid line such that the at least one magnetic filter is exposed directly to the fluid being transported within the fluid line.

In some aspects, the techniques described herein relate to a magnetic filtration system, wherein the impurities include salt ions.

In some aspects, the techniques described herein relate to a magnetic filtration system, wherein the fluid line is in fluid communication with an internal water system of a watercraft such that clean water leaving the fluid line is introduced into the internal water system of the watercraft.

In some aspects, the techniques described herein relate to a method for filtering impurities from a fluid, the method including: introducing particles into a fluid flowing through a fluid line, the fluid including impurities, the particles exhibiting magnetic behavior; capturing the impurities within a structure of the particle; exposing the fluid to a magnetic field generated by at least one magnetic filter; pulling the particles with the impurities trapped within towards the at least one magnetic filter; and extracting clean water.

In some aspects, the techniques described herein relate to a method, further including: removing the at least one magnetic filter from the fluid flow; and cleaning the at least one magnetic filter.

In some aspects, the techniques described herein relate to a method, wherein the particles include MOFs.

In some aspects, the techniques described herein relate to a method, wherein the impurities are salt ions.

### BRIEF DESCRIPTION OF THE DRAWINGS

The detailed description is set forth with reference to the accompanying figures. The use of the same numbers in different figures indicates similar or identical items.

For this discussion, the devices and systems illustrated in the figures are shown having a multiplicity of components. Various implementations of devices and/or systems, as described herein, may include fewer components, and remain within the scope of the disclosure. Alternatively, other implementations of devices and/or systems may include additional components, or various combinations of the described components, and remain within the scope of the disclosure.

FIG. 1 shows a schematic of a magnetic filtration system.

FIG. 2 shows a schematic of a water filtration system including a watercraft.

FIG. 3 shows a schematic of a water filtration system including a floating platform.

FIG. 4 shows a schematic of a water filtration system including a coastal facility.

### DETAILED DESCRIPTION OF THE PREFERRED EMBODIMENT

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

The following detailed description is directed to certain specific embodiments of the development. Reference in this specification to “one embodiment,” “an embodiment,” or “in some embodiments” means that a particular feature, structure, or characteristic described in connection with the embodiment is included in at least one embodiment of the disclosure. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments. Furthermore, embodiments of the development may include several novel features, no single one of which is solely responsible for its desirable attributes or which is essential to practicing any particular embodiment described herein.

The described embodiments relate to systems and methods for filtering salts and other impurities from dirty water, such as salt water and/or sea water, utilizing nano-scale structures like metal organic frameworks (MOFs) and magnetic filters to output fresh water for human and agricultural consumption. Metal organic framework material can be constructed at nano-scale and mixed into saline solution to specifically bond with salt molecules. When this solution passes through magnetic filters the metallically bonded salts can be captured and separated to produce fresh water. This method and apparatus is low cost, scalable in size, and does not require heat or combustion based energy sources for separation.

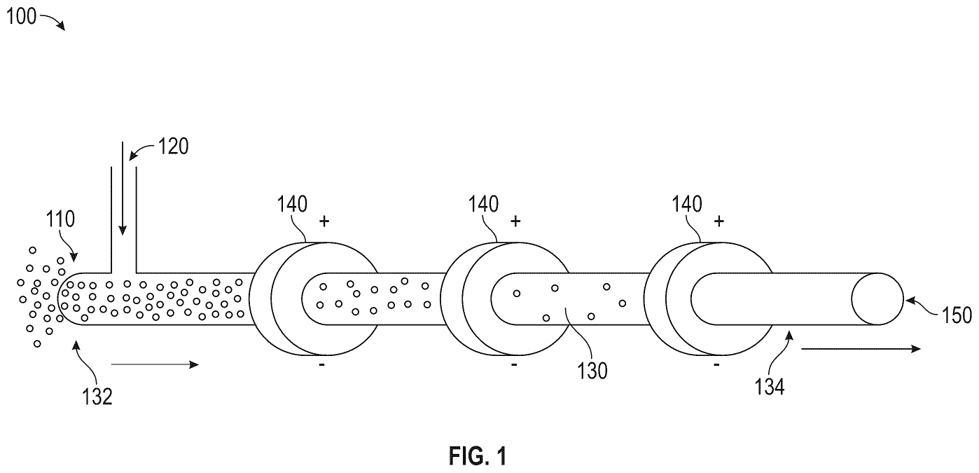

FIG. 1 shows a schematic of a magnetic filtration system 100. The magnetic filtration system 100 includes a fluid inlet 110, a particle inlet 120, a fluid line 130, at least one magnetic filter 140, and a fluid outlet 150.

The fluid inlet 110 is configured to allow a fluid to flow into the fluid line 130. The fluid inlet 110 is in fluid communication with the fluid line 130. In some embodiments, the fluid inlet 130 is located at a first end 132 of the fluid line. In some embodiments, the fluid inlet 110 is in communication with a pump, a siphon, a pneumatic system, a vacuum system, and/or a hydraulic system configured to move fluid through the fluid line 130. In some embodiments, the fluid entering the fluid line 130 is a fluid to be filtered. In some embodiments, the fluid entering the fluid line 130 from the fluid inlet 110 includes sediments, microorganisms, ions and/or organic matter. In some embodiments, the fluid is dirty water, such as sea water or salt water.

The particle inlet 120 is in communication with the fluid line 130. In some embodiments, the particle inlet 120 is located near or at a first end 132 of the fluid line 130. The particle inlet 120 is configured to allow particles to enter the fluid line 130. In some embodiments, the particles are carried into the fluid line 130 by means of a carrier fluid. In some embodiments, the carrier fluid is clean water, such as distilled water, deionized water, filtered water, etc. In some embodiments, the particles are configured to capture impurities in the fluid traveling through the fluid line 130.

In some embodiments, the particles include metal-organic frameworks (MOFs). In some embodiments, the MOFs include metal clusters, which can be referred to as Secondary Building Blocks, linked by organic linkers to form one dimensional, two dimensional, or three-dimensional structures. In some embodiments, the organic linkers are organic ligands, such as benzenediazonium chloride (BDC), benzene-1,3,5-tricarboxylate (BTC), and/or 2-methylimidazole (MeIM). In some embodiments, the MOFs form a porous and/or fibrous structure such as a membrane. In some embodiments, the MOF membrane is a ZIF-8 membrane or a UiO-66 membrane. In some embodiments, the MOF is PSP-MIL-53. In some embodiments, the MOFs exhibit and/or substantial mimic ion selectively. In some embodiments, the MOFs are configured to capture and/or retain alkali metal ions, such as sodium ions, alkaline earth metals, such as magnesium ions, reactive nonmetals, and/or polyatomic ions, such as carbonate ions and sulfate ions. In some embodiments, the MOFs exhibit an ion selectivity higher than 0.5, higher than 1.0, higher than 1.5, higher than 2.0, higher than 2.5, higher than 3.0, higher than 4.0 or higher than 5.0.

In some embodiments, the species targeted to be captured diffuses through the porous nature of the MOF and then is captured within the MOF structure. In some embodiments, the targeted species bonds directly or indirectly with a portion of the MOF, such as with a metal cluster or an organic ligand. In some embodiments, the targeted species may bond or interact with an open coordination site of the MOF. In some embodiments, the targeted species is retained within the MOF by intermolecular forces, such as dipole-dipole forces, ion-dipole forces, ion induced dipole forces, and/or Van der Waals forces. In some embodiments, the MOFs exhibit magnetic behavior. In some embodiments, the MOFs are ferromagnetic, the ferrimagnetic, paramagnetic and/or ferroelectric. In some embodiments, the MOFs are reusable. In some embodiments, the MOFs can be treated post-capture of any impurities such that the impurities are released from the structure of the MOF and the MOF can be reemployed back into the fluid line 130.

The fluid line 130 is configured to transport fluid. In some embodiments, the fluid line 130 may take the form of pipe and/or tubes. In some embodiments, the fluid line 130 is comprised of a plurality of segments. In some embodiments, adjacent segments are separated by one of the at least one magnetic filters 140. In some embodiments, the number of segments of the plurality of segments is one more than the number of the at least one magnetic filters 140. In some embodiments, the fluid line 130 is one continuous line extending from a first end 132 of the fluid line 130 to a second end 134 of the fluid line 130. In some embodiments, the fluid line 130 comprises at least one slot and/or opening located along the length of the fluid line 130. In some embodiments, the slots and/or openings are configured to receive the magnetic filters 140. In some embodiments, the slots and/or openings are configured to expose the at least one magnetic filter 140 directly to the fluid flow within the fluid line 130.

The at least one magnetic filter 140 is disposed on or proximate the fluid line 130. In some embodiments, the at least one magnetic filter 140 includes a plurality of the magnetic filters. In some embodiments, the magnetic filters 140 generate a magnetic field within the fluid line 130. In some embodiments, the magnetic filters 140 take the form of rings that are disposed around the fluid line 130. In some embodiments, the magnetic filters 140 are in the form of a sheet and or a protrusion configured to be inserted the slots and/or openings of the fluid line 130. In some embodiments, the at least one magnetic filter 140 may be in the shape of a square, rectangle, circle or other shape. In some embodiments, the at least one magnetic filter 140 is removably attached to the fluid line 130 such that the magnetic filters 140 can be removed and/or cleaned and then reattached. In some embodiments, when the magnetic filters 140 are attached to the fluid line 130, the magnetic filters 140 are aligned with the slots and/or openings of the fluid line 130 such that the magnetic filters 140 are exposed directly to the fluid flow within the fluid line 130.

In some embodiments, the magnetic filters 140 may be composed at least partially of permanent magnets or electromagnets. In some embodiments, the magnetic filters 140 are formed of a ferromagnetic material, such as, but not limited to, iron, nickel, cobalt, or combinations of the aforementioned materials.

The fluid outlet 150 is configured to allow a fluid to flow out of the fluid line 130. The fluid outlet 150 is in fluid communication with the fluid line 130. In some embodiments, the fluid outlet 150 is located at a second end 134 of the fluid line 130. In some embodiments, the fluid outlet 150 is in communication with a pump, a siphon, a pneumatic system, a vacuum system, and/or a hydraulic system configured to move fluid through the fluid line 130. In some embodiments, the fluid leaving the fluid line 130 is a fluid that is substantially clean. In some embodiments, the fluid leaving the fluid line 130 has an impurity content that is 80% lower than that the fluid entering the fluid line 130. In some embodiments, the fluid leaving the fluid line 130 has an impurity content that is 90% lower than that the fluid entering the fluid line 130. In some embodiments, the fluid leaving the fluid line 130 has an impurity content that is 95% lower than that the fluid entering the fluid line 130. In some embodiments, the impurity content is the salinity of the fluid. In some embodiments, the fluid leaving the fluid line 130 is fresh water. In some embodiments, the fluid leaving the fluid line 130 is potable.

In some embodiments, a fluid containing impurities enters the fluid line 130 via the fluid inlet 110. In some embodiments, the fluid is sea water and/or saltwater containing salt ions. In some embodiments, particles are then introduced to the fluid line 130 by means of the particle inlet 120. In some embodiments, the particles include MOFs that are designed to capture the impurities within the fluid. In some embodiments, the MOFs are configured to capture and/or retain salt ions within the fluid, such as sodium ions, magnesium ions, calcium ions, chloride ions, and/or other ions. In some embodiments, the fluid containing the particles retaining the impurities are then flowed through the fluid line 130 and past one or more magnetic filters 140. The magnetic filters 140 attract and pull the magnetic components of the MOFs such that the MOFs become attached to the magnetic filters 140. The fluid continues flowing through the fluid line 130 substantially or completely devoid of the impurities. In some embodiments, the magnetic filters 140 may be removed from the fluid line 130 and any attached particles cleaned and/or wiped from the magnetic filters 140. After the magnetic filters 140 are cleaned, the magnetic filters 140 are then reattached to the fluid line.

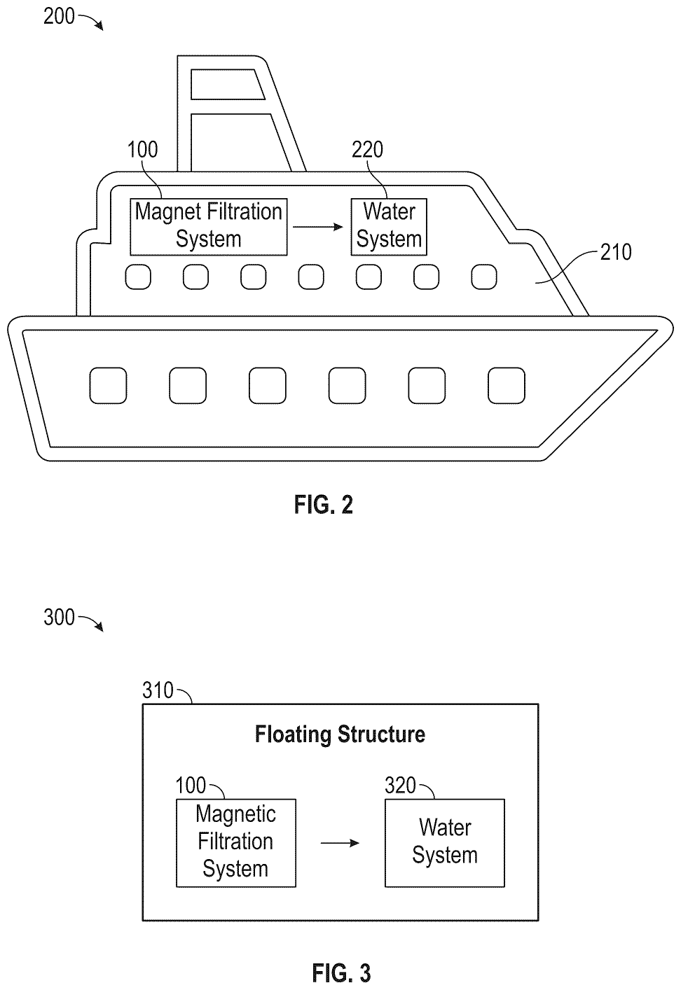

FIG. 2 shows a schematic of a water filtration system 200. The water filtration system 200 may include the magnetic filtration system 100 in use with a watercraft 210 such as a ship, a boat, such as commercial fishing boats, a bass boat, a skiff, a drift boat, a Jon boat, a yacht, or other types of watercraft, or a personal watercraft, such as jet skis, etc. In some embodiments, the magnetic filtration system 100 is in located on the watercraft such that the system 100 draws in sea-water or salt-water directly from the water the watercraft is traveling on. The water is then filtered as described above and then directed to the internal water system 220 of the watercraft 210. In some embodiments, the internal water system 220 may be the internal plumbing of the watercraft 210. In some embodiments, the internal water system provides water to the various facilities of the watercraft 210.

FIG. 3 shows a schematic of a water filtration system 300. The water filtration system 300 may include the magnetic filtration system 100 in use with a floating structure 310, such as a floating platform, a floating building, a military or defense structure, a floating storage/processing unit. In some embodiments, the magnetic filtration system 100 is in located on the floating structure 310 such that the system 100 draws in sea-water or salt-water directly from the water the floating platform is situated on. The water is then filtered as described above and then directed to the internal water system 320 of the floating platform 310. In some embodiments, the internal water system 320 may be the internal plumbing of the floating platform 210. In some embodiments, the internal water system provides water to the various facilities of the floating structure 310.

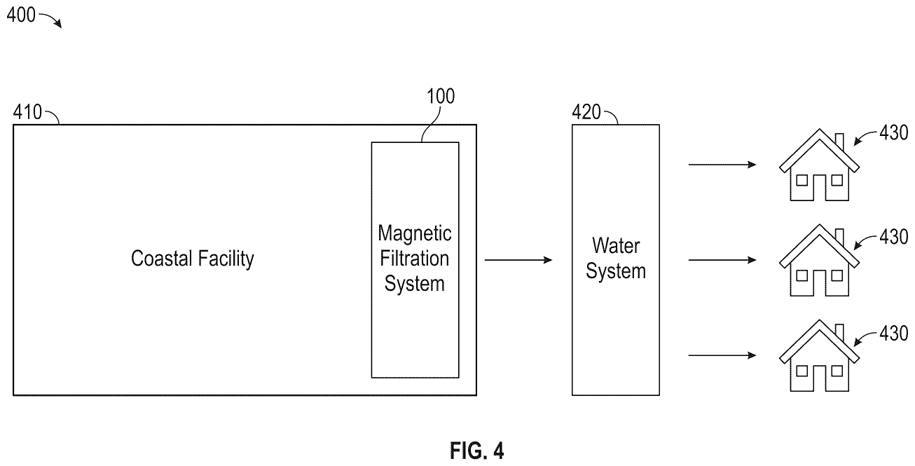

FIG. 4 shows a schematic of a water filtration system 400. The water filtration system 300 may include the magnetic filtration system 100 in use with a coastal facility 410, such as a water treatment facility. In some embodiments, the magnetic filtration system 100 is in located on the coastal facility 410 such that the system 100 draws in sea-water or salt-water directly from the water the coastal facility 410 is situated on or nearby. The water is then filtered within the system 100 as described above and then directed to a water system 420. In some embodiments, the water system 420 may be the water system of a city, municipality or other water systems. In some embodiments, the water system 420 may be a sewage system or drinking water system. In some embodiments, the water system 420 then directs the filtered water to at least one building or domicile 430.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A magnetic filtration system comprising:
a fluid containing impurities;
at least one particle disposed with the fluid, the at least one particle exhibiting magnetic behavior and configured to capture the impurities; and
at least one magnetic filter configured to attract at least one particle with the fluid.

2. The magnetic filtration system of claim 1, wherein the fluid is dirty water.

3. The magnetic filtration system of claim 2, wherein the dirty water is salt water.

4. The magnetic filtration system of claim 1, wherein the at least one particle comprises a metal-organic framework (MOF).

5. The magnetic filtration system of claim 4, wherein the MOF includes at least one of the following: a ZIF-88 membrane, a UiO-66 membrane or PSP-MIL-53.

6. The magnetic filtration system of claim 4, wherein the MOF exhibits ion selectivity, such that a targeted ion can be captured within a structure of MOF.

7. The magnetic filtration system of claim 6, wherein the MOF exhibits alkali metal ion selectivity.

8. The magnetic filtration system of claim 7, wherein the MOF exhibits sodium ion selectivity.

9. The magnetic filtration system of claim 1, wherein the at least one particle exhibits at least one of the following magnetic behaviors: ferromagnetism, ferrimagnetism, or paramagnetism.

10. The magnetic filtration system of claim 1, wherein the at least one particle is ferroelectric.

11. The magnetic filtration system of claim 1, wherein the at least one magnetic filter comprises a plurality of magnetic filters.

12. The magnetic filtration system of claim 1, wherein the at least one magnetic filter is disposed on a fluid line configured to transport the fluid.

13. The magnetic filtration system of claim 12, wherein the at least one magnetic filter is removably attached to the fluid line.

14. The magnetic filtration system of claim 12, wherein the at least one magnetic filter is attached to the fluid line such that the at least one magnetic filter is exposed directly to the fluid being transported within the fluid line.

15. The magnetic filtration system of claim 1, wherein the impurities comprise salt ions.

16. The magnetic filtration system of claim 1, wherein the fluid line is in fluid communication with an internal water system of a watercraft such that clean water leaving the fluid line is introduced into the internal water system of the watercraft.

17. A method for filtering impurities from a fluid, the method comprising:
introducing particles into a fluid flowing through a fluid line, the fluid comprising impurities, the particles exhibiting magnetic behavior;
capturing the impurities within a structure of the particle;
exposing the fluid to a magnetic field generated by at least one magnetic filter;
pulling the particles with the impurities trapped within towards the at least one magnetic filter; and
extracting clean water.

18. The method of claim 17, further comprising:
removing the at least one magnetic filter from the fluid flow; and
cleaning the at least one magnetic filter.

19. The method of claim 17, wherein the particles comprise MOFs.

20. The method of claim 17, wherein the impurities are salt ions.
